(19) United States
(12) Patent Application Publication
(10) Pub. No.: US 2022/0253698 A1
(43) Pub. Date: Aug. 11, 2022

(54) NEURAL NETWORK-BASED MEMORY SYSTEM WITH VARIABLE RECIRCULATION OF QUERIES USING MEMORY CONTENT

(71) Applicant: DeepMind Technologies Limited, London (GB)

(72) Inventors: Andrea Banino, London (GB); Charles Blundell, London (GB); Adrià Puigdomènech Badia, London (GB); Raphael Koster, London (GB); Sudarshan Kumaran, London (GB)

(21) Appl. No.: 17/613,398

(22) PCT Filed: May 22, 2020
(86) PCT No.: PCT/EP2020/064286

§ 371 Date: Nov. 22, 2021

Related U.S. Application Data
(60) Provisional application No. 62/852,214, filed on May 23, 2019.

(51) Int. Cl. G06N 3/08; G06N 3/04; G06N 3/10

(52) U.S. Cl. CPC G06N 3/08; G06N 3/10; G06N 3/0472

(57) ABSTRACT

A neural network based memory system with external memory for storing representations of knowledge items. The memory can be used to retrieve indirectly related knowledge items by recirculating queries, and is useful for relational reasoning. Implementations of the system control how many times queries are recirculated, and hence the degree of relational reasoning, to minimize computation.

### BACKGROUND

This specification relates to neural network-based memory systems with variable recirculation of queries using memory content during retrieval.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network uses some or all of the internal state of the network after processing a previous input in the input sequence in generating an output from the current input in the input sequence.

### SUMMARY

This specification describes a system comprising one or more computers and one or more storage devices storing instructions that when executed by the one or more computers cause the one or more computers to implement a neural network based memory system.

The neural network based memory system may be used to store and retrieve any kind of data or knowledge item, including, for example, text, sound and image data, and may be used to store multiple different kinds of knowledge items. However apart from the slot-based storage described later the general techniques described do not depend on a particular storage format for the knowledge items. Thus the system may be more particularly described as a memory retrieval system. The manner in which memories are retrieved, which involves recirculation of queries using memory content during retrieval, facilitates connecting knowledge items stored in different memory slots, and hence may be useful for relational reasoning tasks using the stored memories. Some implementations of the system control the number of times memories and queries are recirculated, and hence a degree of relational reasoning.

In some implementations a memory in particular an external memory (i.e. separate to the neural network itself), is configured to receive and store representations of knowledge items, optionally a set or sequence of knowledge items. In implementations the memory comprises a set of memory slots each to store a representation of a respective knowledge item.

The system may also include an iterative memory retrieval system configured to iteratively generate a memory system output by, at each of a succession of time steps, combining a current query derived from an input query with data retrieved from the memory at a previous time step. The system may include a query input to receive the input query. The system may also include an output system to determine the memory system output from a query result determined by applying the current query to the memory at a final time step, for example by performing a soft read of the memory using a set of weights derived from the current query. In implementations the system also includes a controller, e.g. comprising a controller neural network, to control a number of time steps performed by the iterative memory retrieval system until the final time step. Thus in implementations the number of time steps performed by the iterative memory retrieval system until the final time step is variable and determined by the controller; i.e. the number of time steps may adapt to a retrieval task defined by the input query. In implementations the iterative memory retrieval system is trained to minimize a number of time steps taken until the final time step, that is to perform an estimated minimum computation necessary to provide an answer (the memory system output).

The data retrieved from the memory at the previous time step may comprise the query result from the previous time step (or data derived therefrom). Also or instead the data retrieved from the memory at the previous time step may comprise attention history data e.g. an attention history vector, such as a set of soft attention values or logits, resulting from applying the current query at the previous time step to the representations of the knowledge items stored in the memory (i.e. it may be indirectly retrieved).

Thus in some implementations the iterative memory retrieval system includes a soft attention subsystem configured to determine the set of soft attention values from the current query, one for each of the set of memory slots. The soft attention subsystem may then determine a (current) set of weights for the set of memory slots e.g. from a combination of the set of soft attention values and the attention history data. The attention history data may comprise a representation of the soft attention values from a previous time step, e.g. a set of logits (which may initially be zero).

The soft attention subsystem may comprise a soft attention neural network, e.g. an MLP (multi-layer perceptron), to process the set of soft attention values, and optionally the attention history data, to determine the set of weights for the set of memory slots.

In some implementations multi-head attention may be employed over the set of memory slots. For example the soft attention subsystem may configured to determine, from the current query, a set of soft attention values for each attention head. The soft attention values from each head may be combined before being processed by the soft attention neural network. Optionally the soft attention neural network may implement dropout and/or layer normalization to improve generalization.

The iterative memory retrieval system may also include a query update subsystem to apply the set of weights to the representations of the knowledge items in the memory slots, more specifically to values derived from the representations of the knowledge items, to determine a query result. The current query may be defined by the input query at an initial time step and may comprise, i.e. incorporate or depend on, the query result from the previous time step thereafter. For example the current query may combine, e.g. sum, a version of the query result and the query result from the previous time step.

The output system may comprise an output neural network to process the query result to generate the memory system output.

In implementations the controller neural network is configured to receive observations from the iterative memory retrieval system and has a halting control output. The halting control output may output halting data each time step e.g. data defining a probability of halting at the time step (i.e. defining a stochastic halting policy), or a binary value directly defining whether or not the iterative memory retrieval system should halt at the time step (defining a stochastic halting policy). The observations may, separately or collectively, define a change in the query result between successive time steps. The controller may be configured to halt the iterative memory retrieval system using the halting control output to control the number of time steps performed until the final time step, e.g. by sampling a halting action according to the defined probability of halting.

The observations at each time step may define a change in query result between time steps. For example the observations may comprise a measure of a change in the set of weights between a current time step and the previous time step, e.g. a distance metric between the weights such as a Bhattacharyya distance. Also or instead the observations at each time step may comprise one or more of: the current query at the current time step; the current query from the previous time step; a value dependent on change in the current query between time steps; the current set of weights; the previous set of weights; a count of a number of time steps taken so far e.g. a time step count starting at t=0, optionally encoded as a one-hot vector.

In implementations the controller comprises a reinforcement learning controller neural network subsystem. The reinforcement learning controller neural network subsystem may comprise one or more recurrent neural network layers e.g. a GRU (gated recurrent unit) layer; these may be followed by one or more output layers, e.g. an MLP (multilayer perceptron).

Then the halting control output may be generated from a halting control policy signal which defines a probability of halting the iterative memory retrieval system. The reinforcement learning controller neural network subsystem may in general implement any type of reinforcement learning technique e.g. a policy-gradient based model-free reinforcement learning technique such as REINFORCE, or an (Advantage) Actor Critic technique or a Q-learning technique.

The neural network based memory system may also include a training engine to train the reinforcement learning controller neural network subsystem using the reinforcement learning technique with a loss function. The loss function may include a term dependent upon a count of a number of time steps taken until the final time step, to encourage minimization of the number of iterations.

The reinforcement learning controller neural network subsystem may be configured to estimate a time-discounted return resulting from halting the iterative memory retrieval system at a time step, and the loss function may be dependent upon the time-discounted return. During training, a correct memory system output may provide a positive reward and an incorrect output a zero reward.

In implementations of the reinforcement learning technique the loss function is further dependent upon a value estimate generated by the reinforcement learning controller neural network subsystem for the time step. The reinforcement learning technique may be REINFORCE (Williams, Machine learning, 8(3-4):229-256, 1992); this may be configured to estimate a state value function (a predicted return as a result of the halting in accordance with a current halting policy) to provide a baseline for determining updates during training, to reduce a variance of the updates.

For example, the training engine may train the controller neural network using gradients of a reinforcement learning objective function [symbol] _{RL} given by:

[symbol]

_{RL}= [symbol] _{π}+α [symbol] _{V}+β [symbol] _{Hop}

[symbol]

π=− [symbol] ₛ_{ₜ}_{˜π}[\hat{R}ₜ]

[symbol]

_{V}= [symbol] ₛ_{ₜ}_{˜π}[(\hat{R}ₜ−V(sₜ,θ))²]

[symbol]

_{Hop}=− [symbol] ₛ_{ₜ}_{˜π}[π(⋅|sₜ,θ)]

where α and β are positive constant values, [symbol] ₛ_{ₜ}_{˜π}[⋅] refers to the expected value with respect to the halting policy (i.e., defined by the current values of the controller neural network parameters θ), V(sₜ,θ) refers to the value estimate generated by the controller neural network for observation sₜ, and \hat{R}ₜ refers to the n-step look-ahead return, e.g., given by:

$${\hat{R}}_{t} = {\sum }_{i = 1}^{n - 1} {γ}^{i} {r}_{t + i} + {γ}^{n} V ( {s}_{t + n} , θ )$$

where γ is a discount factor between 0 and 1, rₜ₊ᵢ is the reward received at time step t+i, and V(sₜ₊ₙ,θ) refers to the value estimate at time step t+n.

In some implementations the system, in particular the iterative memory retrieval system, is configured to determine a key-value pair representing each of the knowledge items. The soft attention subsystem may be configured to determine a similarity measure, e.g. to form a dot product, between the current query, e.g. a current query vector, and the key for each slot to determine the set of soft attention values. The query update subsystem may be configured to apply the set of weights to the values representing the knowledge items in each of the memory slots to determine the query result.

In implementations the iterative memory retrieval system is configured to apply respective (learnt, e.g. linear) key and value projection matrices to the representation of the knowledge item in a memory slot to determine the key-value pair representing the knowledge item in the memory slot. The iterative memory retrieval system may similarly apply a (learnt, e.g. linear) query projection matrix to the input query to provide an encoded query. The encoded query may be used as the current query for at the initial time step.

The system may include an encoder neural network subsystem to encode the knowledge items into the representations of the knowledge items. The encoder neural network subsystem may comprise a convolutional neural network e.g. to encode image data (which here includes video data) and/or a recurrent neural network e.g. to encode sequential data such as (natural language) text data or digitized audio data and/or a neural network to encode a graph representing a physical entity such as a physical structure, molecule, or communications network. An encoded knowledge item may have multiple elements; for example representing multiple words of a text string, in which case each element may be encoded and stored separately in the slot for the knowledge item. Keeping the elements separate from one another within a slot can facilitate relational reasoning using the elements. The encoded knowledge items or elements may also or instead be from multiple input modalities.

There is also described a method of training the computer-implemented neural network based memory system. The method may comprise training the reinforcement learning controller neural network subsystem using a reinforcement learning method to control the number of time steps performed by the iterative memory retrieval system until the final time step.

The training may comprise, at each of a plurality of training iterations: obtaining an observation of the iterative memory retrieval system, wherein the observation defines a change in the query result between a current time step and a previous time step; processing the observation using the reinforcement learning controller neural network subsystem, and in accordance with current values of parameters of the controller neural network, to generate a halting control policy signal e.g. a signal which defines a probability of the binary options of halting or not halting the iterative memory retrieval system; determining a gradient based on e.g. the halting control policy signal, an actual return over one or more the time steps, and a value dependent upon a number of time steps taken to the current time step (where the actual return may be dependent upon the memory system output being correct for one or more of the current/future time steps; and then adjusting values of the of parameters of the controller neural network using the gradient e.g. by backpropagation.

The method may further comprise training the soft attention subsystem and query update subsystem (and projection matrices) using a supervised training technique e.g. by backpropagating gradients of any suitable loss function e.g. a cross-entropy loss. In implementations, during the training the gradients of the respective loss functions are not shared between the controller and the soft attention subsystem and query update subsystem, e.g. during reinforcement learning the gradients are not used to adjust values of the (trained) neural network based memory system. Training of the controller and memory may be performed separately e.g. so that there is a stationary target for the reinforcement learning training, or jointly.

The subject matter described in this specification can be implemented in particular embodiments so as to realize one or more of the following advantages.

The described neural network-based memory systems can be used with any sort of data; some example applications are described later.

The systems are useful for connecting knowledge items stored in different memory slots, and can thus integrate stored memories better than some other techniques. This allows the system to more easily identify relationships between stored knowledge items, and to perform reasoning over these items. This allows the system to perform some types of reasoning/inference task faster, with less memory, reduced computing resources, and more accurately than previously. Examples of such tasks include: a task which involves pairing associated knowledge items; a text and/or visual question answering task; and a task involving determination of the shortest path between nodes of a graph.

For example a set of logical relationships may be defined, for example by encoding a visual and/or natural language textual representation of these and storing the encoded results in memory. The system may then be queried about relationships not explicitly represented in the memory. Thus the system may be used to perform question answering, using questions in speech, text and/or visual form. In some cases the system can perform complex tasks which other techniques cannot.

For example in some applications the memory system may be used as a component of a smart speaker device, implemented locally and/or on a remote server. Such a device may have a speech recognition front end to provide an input query for interrogating the memory; the answer (memory system output) may be provided in any suitable form, e.g. decoded and output as speech or text in a natural language.

In some other applications the memory system may be used as a component of a reinforcement learning or supervised learning system, to enable the system to learn to perform a task faster or with less resources. The task may be, for example, generating or classifying a data item such as an image or digital representation of a sound, or it may be a reinforcement learning task such as controlling a robot or navigating a vehicle. The described memory system may be used to replace another memory component such as a Differentiable Neural Dictionary (Pritzel et al, arXiv:1703.01988) in a reinforcement learning or other machine learning system.

Other examples of tasks include multi-lingual machine translation, and health monitoring and treatment recommendation/alert generation. When used as a component of a reinforcement learning or supervised learning system the memory system may also facilitate better generalization e.g. across multiple different but related tasks.

In implementations the knowledge items stored in the memory are represented in a compressed form. Nonetheless the techniques described for retrieving data from the memory enable information encoded in the memory regarding relationships between the stored representations of the knowledge items to be efficiently accessed. Thus the described neural network-based memory systems may be viewed as implementing a more effective form of data compression.

As previously described some implementations of the system control the number of times memories and queries are recirculated, and hence a degree of relational reasoning. Implementations of the system may learn to control the number of times memories and queries are recirculated. This can further improve computational and memory use efficiency, hence allowing tasks to be performed with reduced computational resources and/or faster, and potentially using less memory.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example of a neural network based memory system.

FIG. 2 is a flow diagram of an example process for storing representations of knowledge items.

FIG. 3 is a flow diagram of an example process for retrieving stored information.

FIG. 4 is a flow diagram of an example process for training the neural network based memory system.

FIG. 5 illustrates an example task which may be performed by the neural network based memory system.

Like reference numbers and designations in the various drawings indicate like elements.

### DETAILED DESCRIPTION

This specification describes a computer implemented, neural network based memory system for storing items of knowledge and for retrieving knowledge items based on a query. More specifically the system is able to link multiple knowledge items so that a query based on one of the knowledge items can retrieve one or more knowledge items indirectly connected to the query. Thus implementations of the system can perform relational reasoning amongst the knowledge items.

For example, a query might identify one knowledge item in a sequence and a memory system output from the system might be a later knowledge item in the sequence; or a query might identify two nodes in a graph and the memory system output might identify a shortest path between the nodes; or the knowledge items may represent a set of statements, the query a question, and the memory system output an answer to the question inferred from the statements.

There is a variety of known architectures in which a neural network is coupled to memory and with enough memory, a sufficiently large model, and enough computational steps, these may be applied to small problems. However as the problem complexity increases the training time and inferential computation time become prohibitive. Implementations of the described system address this problem, and as well as using an efficient architecture adapt the computation time to the complexity of the problem to be solved.

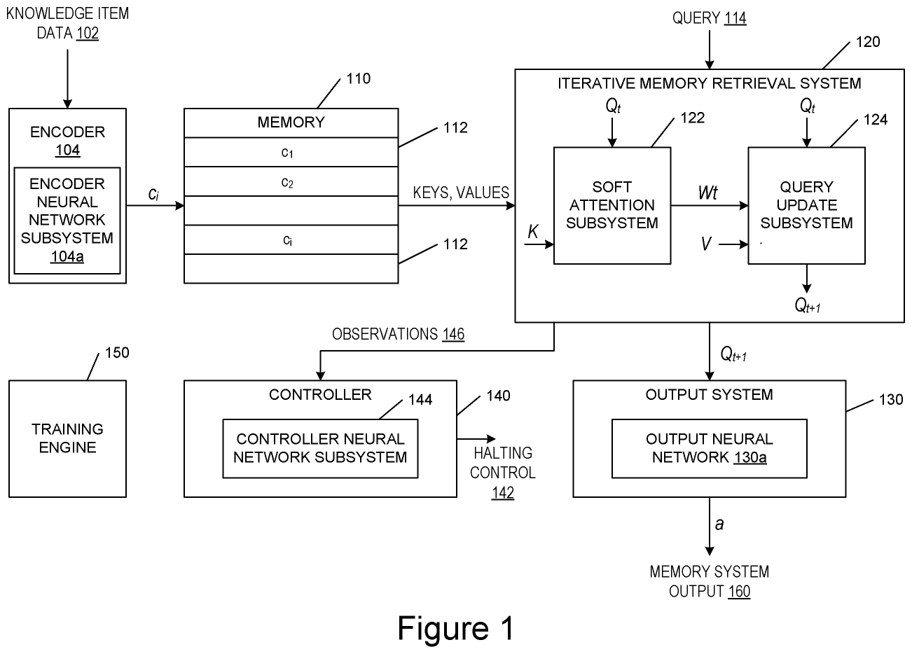

FIG. 1 shows an example of a neural network based memory system 100. The memory system 100 is an example of a system implemented as computer programs on one or more computers in one or more locations, in which the systems, components, and techniques described below can be implemented.

The memory system is configured to receive knowledge item data 102 for a set of knowledge items. An encoder 104 is configured to encode each knowledge item into a common embedding cᵢ. The embedding is common in the sense that each knowledge item is represented in the same embedding space.

Each common embedding is stored in a “slot” 112, or portion, of a memory 110. Thus in implementations memory 110 stores a representation of each knowledge item in a separately identifiable portion of memory. As described later each common embedding is used to derive a respective key and value pair. Alternatively the key and value pairs may be stored in the memory 110 instead of the common embeddings.

A knowledge item, xᵢ, of a set of I knowledge items may comprise a tensor of order 0, 1, 2 or greater. For example a knowledge item, xᵢ, may comprise an S×O matrix which defines a set or sequence of S entities, each entity represented by a vector of length O. The encoder 104 may be configured to encode each knowledge item, xᵢ, into the common embedding cᵢ, which may have dimensions S×d_{c}. For example, the encoder 104 may apply a learned embedding matrix W_{c}, with dimensions O×d_{c}, to determine cᵢ=xᵢW_{c}. The common embedding cᵢ may be stored in a memory “slot” as a vector with S×d_{c} elements. Here a memory “slot” may be a region of memory for storing a tensor e.g. a vector. There may be a defined total number, I, of knowledge items; unused portions of a knowledge item, e.g. for entities which are not present, and/or unused memory slots, may be padded with zeros. The memory 110 may store representations of multiple sets of knowledge items.

In some implementations the encoder 104 includes an encoder neural network subsystem 104a, which may comprise a convolutional and/or recurrent neural network to encode knowledge item data provided in the form of image data and/or audio data. For example an entity may represent an image, and image data for each image of a set of images may be converted into a numeric representation of the image by a (pre-trained) image processing neural network such as a ResNet (arXiv:1512.03385). The knowledge items may then comprise sets of images, and these may then be encoded into the common embedding. In another example audio data may be encoded into numeric representations of entities e.g. words in a natural language by a (pre-trained) audio processing neural network, the knowledge items may comprise sentences in the natural language, and each sentence may be encoded into the common embedding. In some implementations a time e.g. time stamp or other encoding may be included in the memory with the common encoding of each knowledge item, to preserve temporal context. In some other implementations the entities may define nodes of a graph and a knowledge item may define connected nodes of the graph.

The memory system 100 is further configured to receive an input query 114. The input query may have the same modality as the knowledge items e.g. image data, audio data, or other data, or a different modality. In implementations the input query 114 is mapped to a d-dimensional vector defining an initial current query vector q₀, i.e. a current query vector for time step t=0, as described further below, for iteratively querying the memory. An input query may have a fixed size (input dimension), in which case a smaller query may be padded with zeros to the fixed size.

An input query may specify a question to be answered using the representations of the knowledge items stored in the memory, in particular using the relationships between these knowledge items. In general the knowledge items may comprise any sort of data, and the memory system provides a mechanism for establishing a chain of relational reasoning based upon the representations of the knowledge items stored in the memory in response to a query, and for providing an answer to the query.

The memory system 100 includes an iterative memory retrieval system 120 and an output system 130, to iteratively process the input query 114 as described further below to generate a memory system output 160. Broadly, at each of a sequence of time steps the current query is applied to the memory to read data from the memory, which is then used to update the query with new information to provide the current query for the next time step. Thus the current query accumulates data from each time step, and an attention mechanism moves attention over the slots to read relevant information based on relationships between the knowledge items. At the end of the sequence of time steps the current query holds information relating to an answer to the query, a, which is processed by the output system 130 to provide the answer as the memory system output 160. In some implementations the answer a is generated by combining information from the current query at each time step. The memory system 100 is trained using known answers to queries.

As one example a query may identify one or more images in a sequence and require another image in the sequence to be identified by the answer. As another example a query may comprise a question in a natural language, or may comprise audio data for speech defining the question, and may require an answer to the question to be generated using the stored knowledge items; optionally the answer may be converted to speech in the natural language. As a further example a query may identify start and end nodes of a graph and may require one or more nodes along a path, e.g. a shortest path, between the start and end nodes to be identified by the answer.

The memory system 100 includes a controller 140 configured to control the iterative querying of the memory 110. More specifically, the controller 140 receives observations 146 from the iterative memory retrieval system 120, and provides a halting control output 142 which controls when the iterative querying process halts and the answer is to be provided. The halting control output may comprise a binary value sampled from a probability distribution defined by a halting policy, π. In implementations one or more parameters of the probability distribution defined by the halting policy are generated by a controller neural network subsystem 144, which is trained by reinforcement learning. In implementations the controller neural network subsystem 144 is trained with an objective which encourages the iterative querying process to halt after a minimum number of steps needed for a correct answer. Thus the memory system 100 is trained to perform an estimated minimum computation necessary to provide the answer.

A training engine 150 controls training of the memory system 100; this is not needed after training when the memory system is used to retrieve answers to queries. The memory system 100 is trained by adjusting parameters of the system using back propagation of gradients of objective functions. In implementations separate objective functions are used for training the controller 140 and for training the remainder of the memory system 100 and there is no sharing of gradients between these parts of the system. Training of the memory system 100 is described in more detail later.

The iterative memory retrieval system 120 comprises a soft attention subsystem 122 and a query update subsystem 124. In implementations the soft attention subsystem 122 is configured to determine, from the current query qₜ at time step t, a set of weights, wₜ, one for each of the set of memory slots. The set of weights may be determined from a set of soft attention values, hₜ^{(h)}, derived by applying the current query to a set of keys, K, one key, kᵢ, for each memory slot. In some implementations the set of soft attention values, hₜ^{(h)}, includes a weighted contribution from a set of soft attention values, hₜ₋₁^{(h)}, from a previous time step. In some implementations multi-head attention is used, with H heads. The current query may then be denoted Qₜ where each of H rows of Qₜ comprises a vector defining a current query qₜ for a head.

The query update subsystem 124 may then apply the weights to values, V, derived from the representations of the knowledge items in the memory slots to determine a query result, which is processed to determine the current query for the next time step, Qₜ₊₁. Thus the current query at a time step depends on the result of the query at the previous time step; the current query at a time step may also include the query at the previous time step. The query Qₜ₊₁ is processed by a neural network 130a of the output system 130 to determine an answer aₜ for the time step t and the answers for each time step may then be combined to determine the final answer a for the memory system output 160.

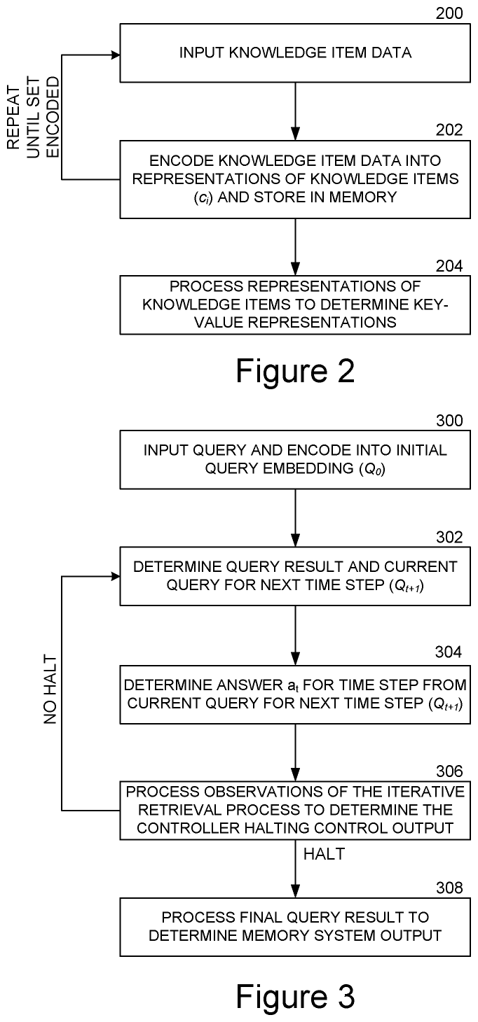

FIG. 2 shows a process which may be implemented by the memory system 100 to receive and store representations of knowledge items. At step 200 the process inputs knowledge item data 102 for a knowledge item, xᵢ of a set of knowledge items. This is then encoded into a representation of the knowledge item, e.g. a common embedding cᵢ as previously described, and stored in one of the memory slots 112 (step 202). The common embedding may be determined according to cᵢ=xᵢW_{c}. The process repeats for knowledge item of the set.

Each common embedding may then be processed to determine a respective key and value (step 204) e.g. according to:

kᵢ=Wₖvec(cᵢ)

vᵢ=Wᵥvec(cᵢ)

where, in the case that cᵢ is a matrix, vec(cᵢ) refers to the operation of flattening the matrix into a vector with the same number of elements (and vec⁻¹(⋅) is the inverse operation).

Each key kᵢ and value vᵢ may be a d-dimensional embedding vector, in which case Wₖ and Wᵥ are matrices each of dimension d×Sd_{c}. A set of keys K for a set of I knowledge items is then a matrix of dimension I×d, and a set of values V for the set of knowledge items similarly has dimension I×d. Where multi-head attention is used, separate matrices Wₖ and Wᵥ are provided for each head, and each head determines a respective set of keys and values.

Step 204 may instead be performed as a first step of the knowledge retrieval process of FIG. 3. The memory may store the keys and values as a representations of each knowledge item as well as or instead of the common embedding; the keys and values may be calculated once, or for each query or as needed.

FIG. 3 shows a process which may be implemented by the memory system 100 to retrieve stored information from the memory system 100 in response to an input query.

At step 300 an input query q is encoded into a d-dimensional query embedding vector q₀, e.g. according to:

q₀=W_{q}^{(h)}_{q}

where W_{q}^{(h)} is a matrix of dimension d×S. Where multi-head attention is used a separate matrix W_{q}^{(h)} is provided for each head and the initial query may be denoted Q₀. In general, with H attention heads a current query Qₜ may be a matrix of dimension H×d.

At step 302 the initial query Q₀, or the current query Qₜ if the process has looped back, is processed to determine the query result and the current query for the next time step, Qₜ₊₁. For example, the current query for the next time step, Qₜ₊₁ may be determined according to:

$${h}_{t}^{( h )} = \frac{1}{\sqrt{d}} {W}_{h} {K}^{( h )} {q}_{t}^{( h )}$$

$${w}_{t}^{( h )} = DropOut ( softmax ( {h}_{t}^{( h )} ) )$$

$${q}_{t + 1}^{( h )} = {w}_{t}^{( h )} {V}^{( h )}$$

$${Q}_{t + 1} = LayerNorm ( {vec}^{- 1} ( {W}_{q} v e c ( {Q}_{t + 1} ) ) + {Q}_{t} )$$

where the superscript (h) denotes a particular attention head so that, for example, qₜ^{(h)} is a row of Qₜ for a particular attention head, and the rows of Qₜ₊₁ are given by qₜ₊₁^{(h)}, Wₕ may be a matrix of dimension I×I, and W_{q} (which is different to W_{q}^{(h)} above) may be a matrix of dimension Hd×Hd. The optional DropOut(⋅) function refers to dropout e.g. as described in Srivastava et al. Journal of Machine Learning Research 15 (2014) 1929-1958; the optional LayerNorm(⋅) function refers to layer normalization e.g. as described in arXiv:1607.06450.

The process then uses the current query for the next time step, Qₜ₊₁ to determine the answer aₜ for the time step t, for example according to:

aₜ=softmax(WₐDropOut(relu(W_{qa}vec(Qₜ₊₁))))

For example the answer aₜ may be a vector of dimension O in which case Wₐ, is a matrix of dimension O×dₐ, and W_{qa} is a matrix of dimension dₐ×Hd where dₐ is an intermediate dimension. In practice the answer aₜ may be determined from Qₜ₊₁ by a neural network e.g. an MLP (multilayer perceptron).

As previously described, the controller 140 processes observations 146 from the iterative memory retrieval system 120 to provide a halting control output 142 (step 306). The observations may include a measure of a difference or distance, e.g. a Bhattacharyya distance, between the attention weights at two successive time steps for example between multi-head attention weights Wₜ and Wₜ₋₁, d(Wₜ, Wₜ₋₁). The observations may also include the number of time steps taken so far, i.e. t, e.g. encoded as a one-hot vector. If the halting control output does not define a halt the process iterates by returning to step 302, otherwise the process continues to step 308. The process may also halt if a maximum number of time steps, e.g. 20 steps, has been reached.

At step 308 the process determines a final answer, a, at final time step T from the answer at each time step answer aₜ, for example according to:

$$a = {\sum }_{t = 1}^{T} {p}_{t} {a}_{t}$$

where pₜ is the halting probability at time step t which may be given by pₜ=σ(πₜ) where πₜ is a halting policy output from the controller neural network subsystem 144 for time step t and σ(⋅) is a sigmoid function. The halting probability for the final time step T may be defined by a remainder probability, R, where R=1−Σₜ₌₁^{T-1}pₜ. The halting control output 142 is determined stochastically according to the halting probability.

In one implementation the controller neural network subsystem 144 comprises a gated recurrent unit (GRU) followed by an MLP to provide the halting policy output πₜ. For example the GRU may implement the update zₜ=GRU(zₜ₋₁,d(Wₜ,Wₜ₋₁),t) where GRU(⋅) is a GRU function and zₜ is an update vector. The policy πₜ at time step t, and an optional value function estimate vₜ used during training, may then be determined by vₜ, πₜ=MLP(zₜ), and pₜ=σ(πₜ).

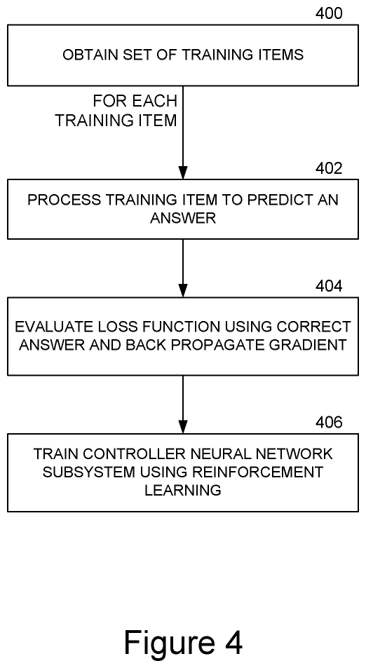

FIG. 4 shows a process which may be implemented by training engine 150 for training the memory system 100. At step 400 the process obtains a set of training items each comprising data for a set of knowledge items xᵢ, an input query q₀, and a correct answer. Each training item is processed as previously described, to store representations of the set of knowledge items in the memory, and to query the memory to produce a predicted final answer (step 402). The learnable parameters of the memory system, except for those of the controller 140, are then adjusted by back propagation of the gradient of a loss function, for example a cross-entropy loss, between the predicted answer and the correct answer (step 404). In implementations the learnable parameters adjusted comprise those of the embedding matrices for the common embedding W_{c}, for the keys and values and query, Wₖ, Wᵥ, W_{q}^{(h)}, for the soft attention Wₕ, for the query construction W_{q}, and for determining the answers Wₐ, W_{qa}.

The controller 140 is trained by reinforcement learning (step 406), e.g. using the REINFORCE algorithm (Williams, R. J. “Simple statistical gradient-following algorithms for connectionist reinforcement learning”, Mach Learn 8, 229-256, 1992). The reward at a time step rₜ may be 1 if the predicted final answer is correct and 0 otherwise and may be evaluated at the end of an episode of T time steps where T is the minimum time for which Σₜ₌₁^{T}pₜ≥1−ϵ where ϵ is a small constant e.g. 0.01. The iteration process may be also stopped, and the reward evaluated, if a predetermined maximum number of time steps is reached.

The parameters of the controller neural network subsystem 144 may be adjusted using reinforcement learning to minimize an objective function [symbol] _{RL} comprising a term [symbol] _{π} dependent upon the reward, an optional term [symbol] _{V} dependent upon a baseline value function V(sₜ) of the observations sₜ at time step t, and a term [symbol] _{Hop} which encourages the iterative memory retrieval process to minimize the number of time steps taken to produce the predicted final answer. For example [symbol] _{RL}= [symbol] _{π}+α [symbol] _{V}+β [symbol] _{Hop} where α and β are weights. In implementations the objective terms are as follows:

[symbol]

_{π}=− [symbol] (\hat{R}ₜ)

[symbol]

_{V}= [symbol] (\hat{R}ₜ−V(sₜ))

[symbol]

_{Hop}=− [symbol] (π(sₜ))

where \hat{R}ₜ is an estimated n-step look ahead return estimate \hat{R}ₜ=Σ_{i=0 . . . n-1}γⁱrₜ₊ᵢ+γⁿV(sₜ₊ₙ), γ is a discount factor, and sₜ are the observations at time step t.

The [symbol] _{Hop} term minimizes the expected number of time steps because the expectation of a binary value is its probability, and the expectation of a sum of these is the sum of their expectations. During training a final layer of the MLP of the controller neural network subsystem 144 may be initialized with a bias that increases the changes that π produces a probability of 1, i.e. of one more time step.

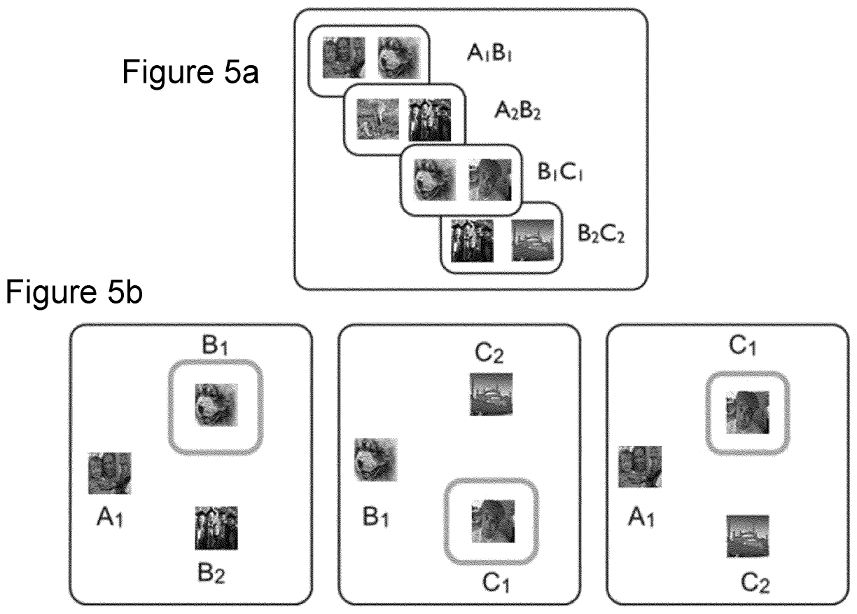

FIG. 5 shows one example of a task which may be performed by the memory system 100 to retrieve stored information from the memory system 100 in response to an image input query. In this example a set of knowledge items comprises images defining a sequence of three images, each knowledge item of the set including only two images of the sequence, the first and second (e.g. A₁B₁) or the second and third (e.g. B₁C₁). The images are represented by image embeddings generated by the encoder neural network subsystem 104a, and representations of multiple different sequences are stored in the memory.

FIG. 5a shows some example knowledge items and FIG. 5b some example queries. A query comprises an embedding of an image from a sequence (left) and embeddings of two other images (right), only one of which is from the sequence, and the task is to select the image belonging to the sequence (outlined in the figure). Implementations of the described system can correctly identify images from a sequence of five images, which other tested systems were not able to do. That is, implementations of the described system can infer long distance associations between stored items of knowledge. Where the items of knowledge are sentences in a natural language, for example from a passage of text, the system is able to reason over the sentences to answer queries. Where the items of knowledge represent a graph the system is able to reason over connections between the nodes.

Some further applications of the system are described below.

A language modeling task that aims to predict a word given a sequence of observed words is one of the relational reasoning tasks that conventional neural networks would struggle on, as this task requires an understanding of how words that were observed in previous time steps are connected or related to each other. The memory-based neural network system described herein can assist such language modeling tasks e.g. in real-world applications such as predictive keyboard and search-phase completion, or can be used as a component within e.g. a machine translation, speech recognition, or information retrieval system.

The memory-based neural network system may be part of a neural machine translation system. In this example, the input may be a sequence of words in an original language, e.g., a sentence or phrase, and the output may be used for a translation of the input sequence into a target language, i.e., a sequence of words in the target language that represents the sequence of words in the original language. Relational reasoning is important for machine translation, especially when a whole sentence or text needs to be translated. In these cases, in order to produce an accurate translation, the system needs to understand the meaning of a whole sentence instead of single words, and therefore needs to understand how the words in the input sequence are connected or related to one other.

The memory-based neural network system may be part of a computer-assisted medical alert, diagnosis or treatment system. For example, the input may be data from an electronic medical record of a patient and the output may comprise information for determining a predicted treatment. To generate a predicted treatment, the system can be used to analyze multiple pieces of data in the input to find relationships between these pieces of data. Based on the relationships, the system can identify, for example, symptoms of a disease and/or progression of an existing disease in order to predict an appropriate treatment for the patient. In another example the input may comprise sensor data from one or more medical sensors or measuring devices sensing or measuring a condition or one or more parameters of a patient, and the memory system output may comprise data representing e.g. a condition or degree of concern or alert for the patient, or data for use in determining a diagnosis or treatment for the patient.

The memory-based neural network system can be used for reinforcement learning tasks such as controlling an agent interacting with an environment, e.g. a real-world environment, that receives as input data characterizing the environment (observations) and in response to each observation generates an output that defines an action to be performed by the agent in order to complete a specified task. The specified task may be, for example, navigating an environment to collect pre-specified items while avoiding moving obstacles, e.g. a robot avoiding other robots on a factory or warehouse floor. Such tasks can be assisted by relational reasoning capability as the system can be used to predict the dynamics of the moving obstacles based on previous observations, and plan the agent's navigation accordingly and/or based on remembered information about which items have already been picked up.

In another example the neural network system may be used in a generative or recurrent neural network system for data item, e.g. image or sound, generation. For example the system may be used in an image generation system such as DRAW (arXiv: 1502.04623), where the memory may be used for the read and write operations in addition to or instead of the described selective attention mechanism, for example to better account for relationships between objects in the generated image.

The memory-based neural network system may be part of an image or audio signal processing recommendation or classification system, for example for classifying/finding/recommending an audio segment, image, video, or product e.g. based upon an input sequence which may represent one or more query images, videos, or products. For example the input may describe a data item which the user wishes to locate in terms of text or in terms of other audio segments, images, videos, or products, and the output may be or be used for determining a recommendation of another related data item.

In general the neural network memory system can be used for or to assist storage/retrieval of any kind of digital data including e.g. Internet resources (e.g., web pages), documents, or portions of documents or features extracted from Internet resources, documents, or portions of documents, images, audio, videos; and/or features of a personalized recommendation for a user. In these cases the memory system may be used to retrieve pertinent data in response to the input query.

As previously described, in some applications the memory-based neural network system may be included in a reinforcement learning system which implements a reinforcement learning technique. For example such a reinforcement learning system may be used to train an agent policy neural network through reinforcement learning for use in controlling an agent to perform a reinforcement learning task while interacting with an environment. For example in response to an observation the reinforcement learning system may select an action to be performed by the agent and cause the agent to perform the selected action. Once the agent has performed the selected action, the environment transitions into a new state and the reinforcement learning system may receive a reward, in general a numerical value. The reward may indicate whether the agent has accomplished the task, or the progress of the agent towards accomplishing the task. For example, if the task specifies that the agent should navigate through the environment to a goal location, then the reward at each time step may have a positive value once the agent reaches the goal location, and a zero value otherwise. As another example, if the task specifies that the agent should explore the environment, then the reward at a time step may have a positive value if the agent navigates to a previously unexplored location at the time step, and a zero value otherwise.

In some implementations, the environment is a real-world environment and the agent is a mechanical agent interacting with the real-world environment, e.g., a robot or an autonomous or semi-autonomous land, air, or sea vehicle navigating through the environment.

In these implementations, the observations may include, e.g., one or more of: images, object position data, and sensor data captured as the agent interacts with the environment, for example sensor data from an image, distance, or position sensor, or data from an actuator.

For example in the case of a robot the observations may include data characterizing a current state of the robot, e.g. one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g. data from sensors of the agent or data from sensors that are located separately from the agent in the environment.

In these implementations, the actions may be control inputs to control the robot, e.g., torques for the joints of the robot or higher-level control commands, or an autonomous or semi-autonomous land, air, sea vehicle, e.g., torques to the control surface or other control elements of the vehicle or higher-level control commands. In other words, the actions can include for example, position, velocity, or force/torque/acceleration data for one or more joints of a robot or parts of another mechanical agent. Action data may additionally or alternatively include electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation e.g. steering, and movement e.g., braking and/or acceleration of the vehicle.

In some implementations the environment is a simulated environment and the agent is implemented as one or more computers interacting with the simulated environment. The simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. In a similar way a robot reinforcement learning system may be partially or wholly trained in simulation before use on a real-world robot. In another example, the simulated environment may be a video game and the agent may be a simulated user playing the video game. Generally, in the case of a simulated environment, the observations may include simulated versions of one or more of the previously described observations or types of observations and the actions may include simulated versions of one or more of the previously described actions or types of actions.

In the case of an electronic agent the observations may include data from one or more sensors monitoring part of a plant or service facility such as current, voltage, power, temperature and other sensors and/or electronic signals representing the functioning of electronic and/or mechanical items of equipment. In some other applications the agent may control actions in a real-world environment including items of equipment, for example in a data center, in a power/water distribution system, or in a manufacturing plant or service facility. The observations may then relate to operation of the plant or facility. For example the observations may include observations of power or water usage by equipment, or observations of power generation or distribution control, or observations of usage of a resource or of waste production. The actions may include actions controlling or imposing operating conditions on items of equipment of the plant/facility, and/or actions that result in changes to settings in the operation of the plant/facility e.g. to adjust or turn on/off components of the plant/facility.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented neural network based memory system, comprising:
a memory configured to receive and store representations of knowledge items, wherein the memory comprises a set of memory slots each to store a representation of a respective knowledge item;
an iterative memory retrieval system configured to iteratively generate a memory system output by, at each of a succession of time steps, combining a current query derived from an input query with data retrieved from the memory at a previous time step;
an output system to determine the memory system output from a query result determined by applying the current query to the memory at a final time step; and
a controller to control a number of time steps performed by the iterative memory retrieval system until the final time step.

2. The system of claim 1 wherein the iterative memory retrieval system comprises: a soft attention subsystem configured to determine from the current query a set of soft attention values, one for each of the set of memory slots, and to determine a set of weights for the set of memory slots from a combination of the set of soft attention values; and a query update subsystem to apply the set of weights to values derived from the representations of the knowledge items in the memory slots to determine the query result, wherein the current query is defined by the input query at an initial time step and depends on the query result from the previous time step thereafter.

3. The system of claim 1 wherein the controller comprises a controller neural network subsystem configured to receive observations from the iterative memory retrieval system and has a halting control output, wherein the observations define a change in the query result between time steps, and wherein the controller is configured to halt the iterative memory retrieval system, using the halting control output, to control the number of time steps performed until the final time step.

4. The system of claim 3 wherein the observations at each time step comprise one or more of: a measure of a change in the set of weights between a current time step and the previous time step; the current query at the current time step; the current query at the previous time step; and a count of a number of time steps taken.

5. The system of claim 1 wherein the controller comprises a reinforcement learning controller neural network subsystem to define a probability of halting the iterative memory retrieval system for the halting control output.

6. The system of claim 5 further comprising a training engine to train the reinforcement learning controller neural network subsystem using a reinforcement learning technique with a loss function dependent upon a count of a number of time steps taken until the final time step.

7. The system of claim 6 wherein the reinforcement learning controller neural network subsystem is configured to estimate a time-discounted return resulting from halting the iterative memory retrieval system at a time step, and wherein the loss function is dependent upon the time-discounted return.

8. The system of claim 7 wherein the reinforcement learning technique is a policy gradient-based reinforcement learning technique and wherein the loss function is further dependent upon a value estimate generated by the reinforcement learning controller neural network subsystem for the time step.

9. The system of claim 2, wherein the system is configured to determine a key-value pair representing each of the knowledge items, wherein the soft attention subsystem is configured to determine a similarity measure between the current query and the key for each memory slot to determine the set of soft attention values, and wherein the query update subsystem is configured to apply the set of weights to the values representing the knowledge items in each of the memory slots to determine the query result.

10. The system of claim 9 wherein the iterative memory retrieval system is configured to apply respective key and value projection matrices to the representation of the knowledge item in a memory slot to determine the key-value pair representing the knowledge item in the memory slot.

11. The system of claim 1 wherein the iterative memory retrieval system is configured to apply a query projection matrix to the input query to provide an encoded query, wherein the encoded query comprises the current query defined by the input query at the initial time step.

12. The system of claim 2 wherein the soft attention subsystem comprises a soft attention neural network to process the set of soft attention values to determine the set of weights for the set of memory slots.

13. The system of claim 1 wherein the output system comprises an output neural network to process the query result to generate the memory system output.

14. The system of claim 1 further comprising an encoder neural network subsystem to encode knowledge item data for the knowledge items into the representations of the knowledge items.

15. The system of claim 14 wherein the encoder neural network subsystem comprises a convolutional neural network.

16. The system of claim 14 wherein the encoder neural network subsystem comprises a recurrent neural network.

17. The system of claim 1 wherein the knowledge items comprise one or more of image items, digitized sound items, text data items, and graph data items.

18-22. (canceled)

23. One or more non-transitory computer readable storage media storing instructions that when executed by one or more computers cause the one or more computers to implement:
a memory configured to receive and store representations of knowledge items, wherein the memory comprises a set of memory slots each to store a representation of a respective knowledge item;
an iterative memory retrieval system configured to iteratively generate a memory system output by, at each of a succession of time steps, combining a current query derived from an input query with data retrieved from the memory at a previous time step;
an output system to determine the memory system output from a query result determined by applying the current query to the memory at a final time step; and
a controller to control a number of time steps performed by the iterative memory retrieval system until the final time step.

24. The non-transitory computer readable storage media of claim 23 wherein the iterative memory retrieval system comprises:
a soft attention subsystem configured to determine from the current query a set of soft attention values, one for each of the set of memory slots, and to determine a set of weights for the set of memory slots from a combination of the set of soft attention values; and a query update subsystem to apply the set of weights to values derived from the representations of the knowledge items in the memory slots to determine the query result, wherein the current query is defined by the input query at an initial time step and depends on the query result from the previous time step thereafter.

25. The non-transitory computer readable storage media of claim 23 wherein the controller comprises a controller neural network subsystem configured to receive observations from the iterative memory retrieval system and has a halting control output, wherein the observations define a change in the query result between time steps, and wherein the controller is configured to halt the iterative memory retrieval system, using the halting control output, to control the number of time steps performed until the final time step.
